(19) United States
(12) Patent Application Publication
(10) Pub. No.: US 2025/0357712 A1
(43) Pub. Date: Nov. 20, 2025

(54) EXTENSIONS DEVICE AND CONTROL SIGNAL CONVERSION METHOD THEREOF

(71) Applicant: DARWIN PRECISIONS CORPORATION, Hsinchu County (TW)

(72) Inventors: CHIH-YING CHENG, Hsinchu County (TW); CHI-FU CHANG, Hsinchu County (TW); HUNG-HAN CHEN, Hsinchu County (TW)

(21) Appl. No.: 19/026,547

(22) Filed: Jan. 17, 2025

(30) Foreign Application Priority Data
May 15, 2024 (TW) 113117979

(51) Int. Cl. H01R 33/05; G06F 13/40

(52) U.S. Cl. CPC H01R 33/05; G06F 13/4063; G06F 2213/40

(57) ABSTRACT

An extensions device includes the following features. The transition assembly has a first hot shoe head, a first connecting portion and a signal conversion circuit. The signal conversion circuit is electrically connected to the first hot shoe head and the first connecting portion. The signal conversion circuit converts a first control signal received by the first hot shoe head to a second control signal and transmits the second control signal to the first connecting portion, wherein the first control signal and the second control signal have respectively communication protocol. The electronic assembly has a second connecting portion and a processing circuit. The second connecting portion is electrically connected to the first connecting portion and the processing circuit. The second connecting portion receives the second control signal from the first connecting portion. The processing circuit is adapted to trigger a function of the electronic assembly according to the second control signal.

### FIELD OF THE INVENTION

The present invention relates to an extensions device, and more particularly to an extensions device for an electronic device and a control signal conversion method for the extensions device.

### BACKGROUND OF THE INVENTION

Electronic devices such as smartphones, digital cameras, and tablets have been widely used in daily life. The various electronic devices mentioned above can be equipped with extensions devices to provide more functions through extensions devices. For example, a digital camera is usually equipped with an additional flash to enhance the contrast between in photos. Also, the digital camera can be equipped with an additional monitor, so that when using a digital camera to record videos, the monitor can display the videos more clearly.

However, when the electronic device is equipped with extensions devices of different brands, it is often impossible to fully operate the extensions device from the electronic device. For example, when a monitor is equipped with a digital camera with a different communication protocol, although the monitor still can display videos recorded by the digital camera, functions of the digital camera and the monitor can only be operated separately. The digital camera cannot be used to operate the functions such as turning on/off or standby of the monitor.

### SUMMARY OF THE INVENTION

The present invention provides an extensions device, which is able to have good expandability.

The present invention provides a control signal conversion method, which is able to improve expandability of an extensions device.

To achieve one, part or all of the above purposes or other purposes, an extensions device provided by the present invention is for an electronic device having a first hot shoe. The electronic device is adapted to transmit a first control signal through the first hot shoe, and the first control signal has a first communication protocol corresponding to the first hot shoe. The extensions device includes a transfer assembly and an electronic assembly. The transfer assembly has a first hot shoe head and a first connecting portion, and the transfer assembly includes a signal converting circuit. The first hot shoe head is adapted to be electrically connected to the first hot shoe. The signal converting circuit is electrically connected to the first hot shoe head and the first connecting portion. The electronic assembly has a second connecting portion, and the electronic assembly includes a processing circuit. The second connecting portion is adapted to be electrically connected to the first connecting portion, and the processing circuit is electrically connected to the second connecting portion. The second connecting portion has a second communication protocol. The first hot shoe head is adapted to receive the first control signal through the first hot shoe. The signal converting circuit is adapted to convert the first control signal to a second control signal complying with the second communication protocol, and the signal converting circuit is adapted to transmit the second control signal to the first connecting portion. The second connecting portion is adapted to receive the second control signal through the first connecting portion. The processing circuit is adapted to trigger a function of the electronic assembly according to the second control signal.

In an embodiment of the present invention, the first hot shoe head is adapted to convert the first pin assignment of the first control signal to the second pin assignment and transmit the first control signal having the second pin assignment to the signal converting circuit. The first connecting portion and the second connecting portion comply with the second pin assignment.

In an embodiment of the present invention, the signal converting circuit is adapted to convert the first control signal having a first voltage level to the second control signal having a second voltage level.

In an embodiment of the present invention, the electronic assembly can further include a voltage divider circuit and a function-executing element. The voltage divider circuit is electrically connected to the second connecting portion and the processing circuit, and the function-executing element is electrically connected to the processing circuit. The voltage divider circuit is adapted to transmit an executing signal to the processing circuit after the processing circuit receives the second control signal. The processing circuit is adapted to transmit the executing signal to the function-executing element.

In an embodiment of the present invention, the first connecting portion may include, for example, a second hot shoe, and the second connecting portion may include a second hot shoe head.

In an embodiment of the present invention, the electronic assembly may include a display assembly.

To achieve one, part or all of the above purposes or other purposes, a control signal conversion method for the extensions device provided by the present invention is for the extensions device. The control signal conversion method includes the steps of: configuring the signal converting circuit to receive the first control signal through the first hot shoe head and convert the first control signal to the second control signal, wherein the second control signal complies with the second communication protocol; and configuring the processing circuit to receive the second control signal through the second connecting portion and trigger a function of the electronic assembly corresponding to the second control signal.

In an embodiment of the present invention, before the signal converting circuit receives the first control signal through the first hot shoe head and converts the first control signal to the second control signal, the control signal conversion method further includes a step of: configuring the first hot shoe head to convert the first pin assignment of the first control signal to the second pin assignment and transmit the first control signal having the second pin assignment to the signal converting circuit, wherein the first connecting portion and the second connecting portion comply with the second pin assignment.

In an embodiment of the present invention, when the signal converting circuit receives the first control signal through the first hot shoe head and converts the first control signal to the second control signal, which includes a step of: configuring the signal converting circuit to convert the first control signal having the first voltage level to the second control signal having the second voltage level.

In an embodiment of the present invention, when the processing circuit receives the second control signal through the second connecting portion and triggers the function of the electronic assembly corresponding to the second control signal, which includes a step of: configuring a voltage divider circuit to transmit the executing signal to the processing circuit, and configuring the processing circuit to transmit the executing signal to the function-executing element and trigger the function-executing element to perform the function.

The extensions device of the present invention uses the transfer assembly and the electronic assembly, wherein the signal converting circuit of the transfer assembly is able to convert the first control signal of the electronic device to the second control signal and make the second control signal have the second communication protocol complying with the first connecting portion and the second connecting portion. Hence, the processing circuit is able to correctly read the second control signal and accordingly trigger the function of the electronic assembly corresponding to the second control signal. Additionally, the transfer assembly can be directly controlled by the electronic device as being assembled to the electronic device through the first hot shoe head and electrically connected to the electronic device, so that the process of electrically connected the transfer assembly to the electronic device is quite simple, and the first hot shoe head and the first hot shoe assembled with each other further have the advantage of having a firm and stable structure. Based on the above, the extensions device of the present invention has good expandability and also has the advantages of being easily and stably assembled, thereby substantially improving the convenience of use of the transfer assembly. Because the control signal conversion method of the present invention is able to convert the first control signal of the electronic device to the second control signal having the second communication protocol and the electronic assembly is able to correctly read the second control signal, so the control signal conversion method can improve the expandability of the extensions device.

### BRIEF DESCRIPTION OF THE DRAWINGS

The present invention will become more readily apparent to those ordinarily skilled in the art after reviewing the following detailed description and accompanying drawings, in which:

FIG. 1 is a block schematic diagram of an extensions device in an embodiment of the present invention;

FIG. 2 is a schematic diagram of one of the examples of implementation of the extensions device of FIG. 1.

FIG. 3 is a flowchart schematic diagram of a control signal conversion method in an embodiment of the present invention;

FIG. 4 is a flowchart schematic diagram of a control signal conversion method in another embodiment of the present invention;

FIG. 5 is a flowchart schematic diagram of a control signal conversion method in another embodiment of the present invention; and

FIG. 6 is a flowchart schematic diagram of a control signal conversion method in another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

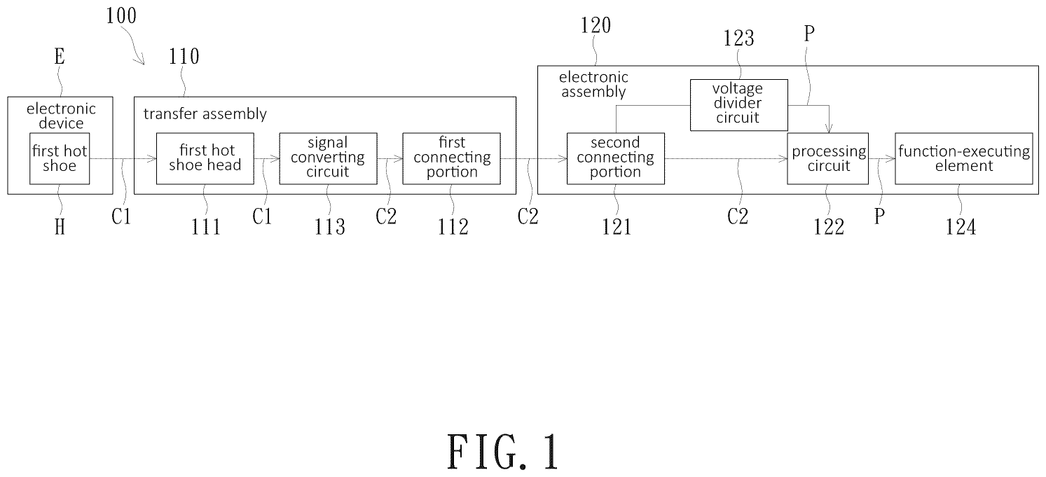

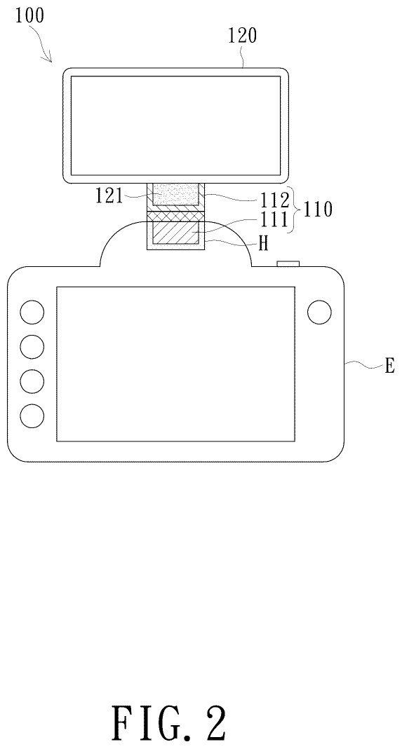

FIG. 1 is a block schematic diagram of an extensions device in an embodiment of the present invention. FIG. 2 is a schematic diagram of one of the examples of implementation of the extensions device of FIG. 1. Referring to FIGS. 1 and 2, an extensions device 100 is for an electronic device E having a first hot shoe H. The electronic device E is adapted to transmit a first control signal C1 through the first hot shoe H, and the first control signal C1 has a first communication protocol corresponding to the first hot shoe H. The extensions device 100 includes a transfer assembly 110 and an electronic assembly 120. The transfer assembly 110 has a first hot shoe head 111 and a first connecting portion 112, and the transfer assembly 110 includes a signal converting circuit 113. The first hot shoe head 111 is adapted to be electrically connected to the first hot shoe H. The signal converting circuit 113 is electrically connected to the first hot shoe head 111 and the first connecting portion 112. The electronic assembly 120 has a second connecting portion 121, and the electronic assembly 120 includes a processing circuit 122. The second connecting portion 121 is adapted to be electrically connected to the first connecting portion 112, and the processing circuit 122 is electrically connected to the second connecting portion 121. The second connecting portion 121 has a second communication protocol. The first hot shoe head 111 is adapted to receive the first control signal C1 through the first hot shoe H. The signal converting circuit 113 is adapted to convert the first control signal C1 to a second control signal C2 complying with the second communication protocol and transmit the second control signal C2 to the first connecting portion 112. The second connecting portion 121 is adapted to receive the second control signal C2 through the first connecting portion 112. The processing circuit 122 is adapted to trigger a function of the electronic assembly 120 according to the second control signal C2. It should be noted that the electronic device E in this embodiment is exemplified by a digital camera, but the present invention is not limited thereto.

The first connecting portion 112 of the transfer assembly 110 can be assembled and electrically connected to the second connecting portion 121 of the electronic assembly 120 in this embodiment. Particularly, the first connecting portion 112 includes, for example, a second hot shoe, and the second connecting portion 121 may include a second hot shoe head. In other words, the transfer assembly 110 and the electronic assembly 120 can be assembled with each other through the first hot shoe and the first hot shoe head, and because the first hot shoe and the first hot shoe head assembled with each other have the advantage of stable structure, the firmness of the transfer assembly 110 and the electronic assembly 120 being assembled with each other can be improved.

The first hot shoe head 111 of the transfer assembly 110 is adapted to convert the first pin assignment of the first control signal C1 to the second pin assignment and transmit the first control signal C1 having the second pin assignment to the signal converting circuit 113, wherein the first connecting portion 112 and the second connecting portion 121 comply with the second pin assignment. Particularly, the first hot shoe H of the electronic device E has, for example, the first pin assignment, and the first hot shoe head 111, the first connecting portion 112, and the second connecting portion 121 of the transfer assembly 110 can have the second pin assignment. Furthermore, because the second pin assignment is different from the first pin assignment, the second communication protocol is different from the first communication protocol. Therefore, the first pin assignment of the first control signal C1 is converted to the second pin assignment by the first hot shoe head 111, so the first connecting portion 112 and the second connecting portion 121 can correctly read the first control signal C1 having the second pin assignment. However, the first communication protocol may be the same as the second communication protocol in one embodiment, and in this case, the electronic assembly 120 can be still operated by the electronic device E through the transfer assembly 110.

The signal converting circuit 113 is adapted to convert the first control signal C1 having a first voltage level to the second control signal C2 having a second voltage level in this embodiment, wherein the second voltage level complies with, for example, a voltage level of the processing circuit 122. Specifically, the first control signal C1 can have the first voltage level, but the first voltage level may not comply with the voltage level that the processing circuit 122 is able to read. Therefore, the voltage level of the first control signal C1 is converted via the transfer assembly 110, so that the processing circuit 122 can be effectively triggered by the second control signal C2.

The electronic assembly 120 in this embodiment may include a display assembly. Particularly, the display assembly may include, for example, a screen. The electronic assembly 120 can further include a voltage divider circuit 123 and a function-executing element 124 (both shown in FIG. 1). The voltage divider circuit 123 is electrically connected to the second connecting portion 121 and the processing circuit 122, and the function-executing element 124 is electrically connected to the processing circuit 122. After the processing circuit 122 receives the second control signal C2, the voltage divider circuit 123 transmits an executing signal P to the processing circuit 122. The processing circuit 122 is adapted to transmit the executing signal P to the function-executing element 124. Specifically, the voltage level of the executing signal P is a voltage level that is able to trigger the function-executing element 124, so that the function-executing element 124 can be effectively triggered by the executing signal P to perform the function.

For example, the electronic device E in this embodiment is configured as a digital camera, and the function-executing element 124 may include a power switch. The first control signal C1 for triggering the power switch is generated by long pressing a shutter of the digital camera, and the first control signal C1 is converted to the second control signal C2 by the transfer assembly 110. The voltage level of the power switch is, for example, 3V in an embodiment. Therefore, after the processing circuit 122 receives the second control signal C2, the voltage divider circuit 123 can generate the executing signal P with the voltage level of 3V for the processing circuit 122 to trigger the power switch. Hence, the electronic assembly 120 can be controlled to turn on or off by long pressing the shutter.

Similarly, the function-executing element 124 may include a function menu button in another embodiment, the first control signal C1 for triggering the function menu button may be generated by short pressing the shutter of the digital camera and converted to the second control signal C2 via the transfer assembly 110. The voltage level of the function menu button is, for example, 1.5V. Therefore, after the processing circuit 122 receives the second control signal C2, the voltage divider circuit 123 can generate the executing signal P with the voltage level of 1.5V for the processing circuit 122 to trigger the function menu button. Hence, the function menu of the electronic assembly 120 can be activated by short pressing the shutter. It can be understood that the above description of operating the electronic assembly 120 through the electronic device E is only an example, which is not used to limit the present invention.

Incidentally, the processing circuit 122 includes, for example, a System on a Chip (SoC) in this embodiment, and the extensions device 100 may further be provided with a signal processing element in an embodiment. The signal processing element may be electrically connected to the second connecting portion 121 and the processing circuit 122 to convert the second control signal C2 to a signal type read by the electronic assembly 120.

Compared to the conventional art, the extensions device 100 in this embodiment uses the transfer assembly 110 and the electronic assembly 120, wherein the signal converting circuit 113 of the transfer assembly 110 is able to convert the first control signal C1 of the electronic device E to the second control signal C2 and make the second control signal C2 have the second communication protocol complying with the first connecting portion 112 and the second connecting portion 121. Hence, the processing circuit 122 is able to correctly read the second control signal C2 and accordingly trigger the function of the electronic assembly 120 corresponding to the second control signal C2. Additionally, the transfer assembly 110 can be directly controlled by the electronic device E as being assembled and electrically connected to the first hot shoe H of the electronic device E through the first hot shoe head 111, so that the process of electrically connected the transfer assembly 110 to the electronic device E is quite simple, and the first hot shoe head 111 and the first hot shoe H assembled with each other further have the advantage of having a firm and stable structure. Based on the above, the extensions device 100 in this embodiment has good expandability and also has the advantages of being easily and stably assembled, thereby substantially improving the convenience of use of the transfer assembly 110.

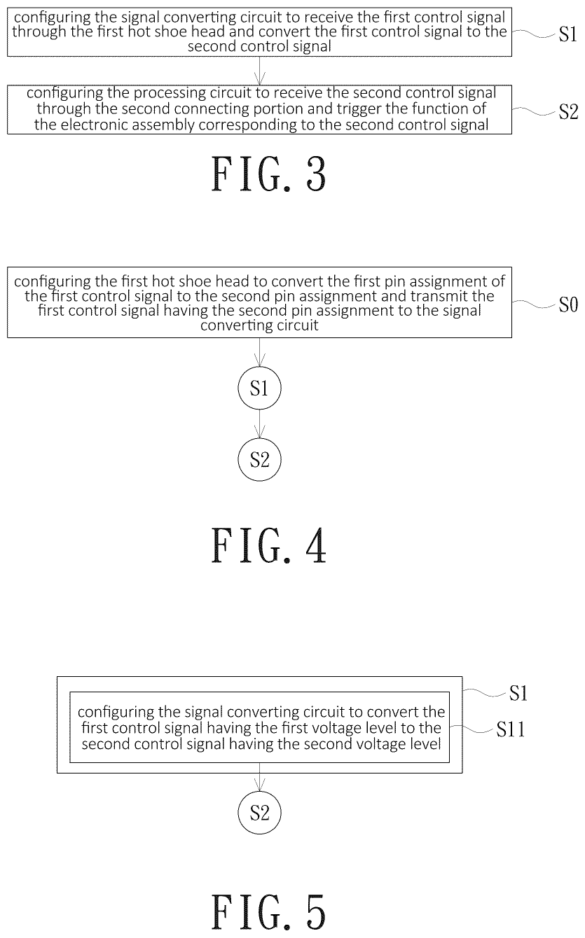

FIG. 3 is a flowchart schematic diagram of a control signal conversion method in an embodiment of the present invention. Referring to FIGS. 1 and 3, the control signal conversion method is applicable to the extensions device 100. The control signal conversion method includes the following steps. Referring to FIG. 1 and FIG. 3 first, the control signal conversion method includes: configuring the signal converting circuit 113 to receive the first control signal C1 through the first hot shoe head 111 and convert the first control signal C1 to the second control signal C2 (step S1), wherein the second control signal C2 complies with the second communication protocol. Then, after the first control signal C1 is converted to the second control signal C2, the control signal conversion method further includes: configuring the processing circuit 122 to receive the second control signal C2 through the second connecting portion 121 and trigger the function of the electronic assembly 120 corresponding to the second control signal C2 (step S2). As mentioned before, because the second connecting portion 121 of the electronic assembly 120 complies with the second communication protocol, the second connecting portion 121 is able to receive and transmit the second control signal C2 to the processing circuit 122 in a correct format, thereby triggering the function of electronic assembly 120 through the second control signal C2.

Compared to the conventional art, because the control signal conversion method in this embodiment is able to convert the first control signal C1 of the electronic device E to the second control signal C2 having the second communication protocol and the electronic assembly 120 is able to correctly read the second control signal C2, the extensions device 100 can be operated by the electronic device E with different communication protocols.

FIG. 4 is a flowchart schematic diagram of a control signal conversion method in another embodiment of the present invention. The features and advantages of the control signal conversion method in this embodiment are similar to those of the embodiment in FIG. 3, and only the differences are described below. Referring to FIGS. 1 and 4, the control signal conversion method in this embodiment can further include the following step before the step S1 is performed. Referring to FIG. 1, the control signal conversion method in this embodiment further includes: configuring the first hot shoe head 111 to convert the first pin assignment of the first control signal C1 to the second pin assignment and transmit the first control signal C1 having the second pin assignment to the signal converting circuit 113 (step S0), wherein the first connecting portion 112 and the second connecting portion 121 comply with the second pin assignment. Hence, the first connecting portion 112 and the second connecting portion 121 can receive and transmit the second control signal C2 in the correct format, so that the processing circuit 122 can trigger the function of the electronic assembly 120 based on the second control signal C2. Hence, the first connecting portion 112 and the second connecting portion 121 are able to receive and transmit the second control signal C2 in the correct format for the processing circuit 122 to trigger the function of the electronic assembly 120 according to the second control signal C2.

FIG. 5 is a flowchart schematic diagram of a control signal conversion method in another embodiment of the present invention. The features and advantages of the control signal conversion method in this embodiment are similar to those of the embodiment in FIG. 3, and only the differences are described below. Referring to FIGS. 1 and 5, the step S1 can further include the following step when the step S1 is performed. Referring to FIGS. 1 and 5, the control signal conversion method includes: configuring the signal converting circuit 113 to convert the first control signal C1 having the first voltage level to the second control signal C2 having the second voltage level (step S11), wherein the second voltage level complies with the voltage level of the processing circuit 122. Particularly, the first voltage level of the first control signal C1 may not comply with the voltage level of the processing circuit 122, therefore, the first control signal C1 is converted to the second control signal C2 having the second voltage level via the signal converting circuit 113, so as to effectively trigger the processing circuit 122 through the second control signal C2.

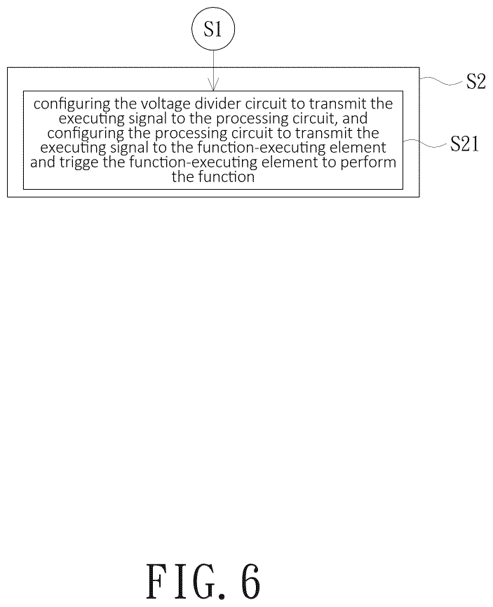

FIG. 6 is a flowchart schematic diagram of a control signal conversion method in another embodiment of the present invention. The features and advantages of the control signal conversion method in this embodiment are similar to those of the embodiment in FIG. 3, and only the differences are described below. Referring to FIGS. 1 and 6, the step S2 includes, for example, the following step when the step S2 is performed. Referring to FIGS. 1 and 6, the control signal conversion method includes: configuring the voltage divider circuit 123 to transmit the executing signal P to the processing circuit 122, and configuring the processing circuit 122 to transmit the executing signal P to the function-executing element 124 and trigger the function-executing element 124 to perform the function (step S21). Specifically, the voltage level of the second control signal C2 may not comply with the voltage level adapted to trigger the function-executing element 124, therefore, the voltage divider circuit 123 can generate the executing signal P after the processing circuit 122 receives the second control signal C2, and the voltage level of the executing signal P is the voltage level being able to trigger the function-executing element 124, thereby making the processing circuit 122 being able to effectively trigger the function-executing element 124 to perform the function by the executing signal P.

In summary, the extensions device of the present invention uses the transfer assembly and the electronic assembly, wherein the signal converting circuit of the transfer assembly is able to convert the first control signal of the electronic device to the second control signal and make the second control signal have the second communication protocol complying with the first connecting portion and the second connecting portion. Hence, the processing circuit is able to correctly read the second control signal and accordingly trigger the function of the electronic assembly corresponding to the second control signal. Additionally, the transfer assembly can be directly controlled by the electronic device as being assembled to the electronic device through the first hot shoe head and electrically connected to the electronic device, so that the process of electrically connected the transfer assembly to the electronic device is quite simple, and the first hot shoe head and the first hot shoe assembled with each other further have the advantage of having a firm and stable structure. Based on the above, the extensions device of the present invention has good expandability and also has the advantages of being easily and stably assembled, thereby substantially improving the convenience of use of the transfer assembly. Because the control signal conversion method of the present invention is able to convert the first control signal of the electronic device to the second control signal having the second communication protocol and the electronic assembly is able to correctly read the second control signal, so the control signal conversion method can improve the expandability of the extensions device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An extensions device for an electronic device having a first hot shoe, the electronic device being adapted to transmit a first control signal through the first hot shoe, the first control signal having a first communication protocol corresponding to the first hot shoe, and the extensions device comprising:
a transfer assembly, having a first hot shoe head and a first connecting portion and comprising a signal converting circuit, wherein the first hot shoe head is adapted to be electrically connected to the first hot shoe, and the signal converting circuit is electrically connected to the first hot shoe head and the first connecting portion; and
an electronic assembly, having a second connecting portion and comprising a processing circuit, wherein the second connecting portion is adapted to be electrically connected to the first connecting portion, the processing circuit is electrically connected to the second connecting portion, and the second connecting portion has a second communication protocol;
wherein the first hot shoe head is adapted to receive the first control signal through the first hot shoe, the signal converting circuit is adapted to convert the first control signal to a second control signal complying with the second communication protocol and transmit the second control signal to the first connecting portion, the second connecting portion is adapted to receive the second control signal through the first connecting portion, and the processing circuit is adapted to trigger a function of the electronic assembly according to the second control signal.

2. The extensions device according to claim 1, wherein the first hot shoe head is adapted to convert a first pin assignment of the first control signal to a second pin assignment and transmit the first control signal having the second pin assignment to the signal converting circuit, and the first connecting portion and the second connecting portion comply with the second pin assignment.

3. The extensions device according to claim 1, wherein the signal converting circuit is adapted to convert the first control signal having a first voltage level to the second control signal having a second voltage level.

4. The extensions device according to claim 1, wherein the electronic assembly further comprises a voltage divider circuit and a function-executing element, the voltage divider circuit is electrically connected to the second connecting portion and the processing circuit, the function-executing element is electrically connected to the processing circuit, the voltage divider circuit is adapted to transmit an executing signal to the processing circuit after the processing circuit receives the second control signal, and the processing circuit is adapted to transmit the executing signal to the function-executing element.

5. The extensions device according to claim 1, wherein the first connecting portion comprises a second hot shoe, and the second connecting portion comprises a second hot shoe head.

6. The extensions device according to claim 1, wherein the electronic assembly comprises a display assembly.

7. A control signal conversion method for an extensions device, the extensions device for an electronic device having a first hot shoe, the electronic device being adapted to transmit a first control signal through the first hot shoe, the first control signal having a first communication protocol corresponding to the first hot shoe, and the extensions device comprising a transfer assembly and an electronic assembly, the transfer assembly having a first hot shoe head and a first connecting portion and the transfer assembly comprising a signal converting circuit, wherein the first hot shoe head is adapted to be electrically connected to the first hot shoe, and the signal converting circuit is electrically connected to the first hot shoe head and the first connecting portion, the electronic assembly having a second connecting portion, and the electronic assembly comprising a processing circuit, wherein the second connecting portion is adapted to be electrically connected to the first connecting portion, the processing circuit is electrically connected to the second connecting portion, and the second connecting portion has a second communication protocol, the control signal conversion method comprises steps of:
configuring the signal converting circuit to receive a first control signal through the first hot shoe head and convert the first control signal to a second control signal, wherein the second control signal complies with the second communication protocol; and
configuring the processing circuit to receive the second control signal through the second connecting portion and trigger a function of the electronic assembly corresponding to the second control signal.

8. The control signal conversion method according to claim 7, further comprising a step of:
configuring the first hot shoe head to convert a first pin assignment of the first control signal to a second pin assignment and transmit the first control signal having the second pin assignment to the signal converting circuit.

9. The control signal conversion method according to claim 7, further comprising a step of:
configuring the signal converting circuit to convert the first control signal having a first voltage level to the second control signal having a second voltage level.

10. The control signal conversion method according to claim 7, further comprising a step of:
configuring a voltage divider circuit to transmit an executing signal to the processing circuit, and configuring the processing circuit to transmit the executing signal to a function-executing element and trigger the function-executing element to execute the function.
